(19) United States
(12) Patent Application Publication
(10) Pub. No.: US 2015/0324135 A1
(43) Pub. Date: Nov. 12, 2015

(54) AUTOMATIC STORAGE SYSTEM CONFIGURATION BASED ON WORKLOAD MONITORING

(71) Applicant: NetApp, Inc., Sunnyvale, CA (US)

(72) Inventors: Bernard Heng Po Chan, Wichita, KS (US); Mahmoud K. Jibbe, Wichita, KS (US)

(73) Assignee: NetApp, Inc., Sunnyvale, CA (US)

(21) Appl. No.: 14/271,003

(22) Filed: May 6, 2014

(51) Int. Cl. G06F 3/06; G06F 12/08

(52) U.S. Cl. CPC G06F 3/0616; G06F 12/0831; G06F 3/0689; G06F 3/0665; G06F 3/061; G06F 2212/621; G06F 2003/0692

(57) ABSTRACT

Storage system workload data associated with a storage system is analyzed. The workload data comprises indications of input and output operations associated with the storage system. A storage system configuration is determined based, at least in part, on said analyzing of the storage system workload data. An implementation plan comprising one or more operations for implementing the storage system configuration is generated.

### BACKGROUND

Aspects of the disclosures herein generally relate to the field of storage systems, and, more particularly, to storage system workload analysis.

Storage system optimization can include the customization of many configurable options. An administrator might try to determine the configuration settings that best fit the applications that utilize the storage system. However, if the configuration settings are not aligned with the actual storage system workload, the performance of the storage system may suffer. Further, storage system usage can vary over the lifetime of the storage system. Thus, beyond knowing how to configure a storage system (which might not be within the purview of an administrator), the storage system usage should be monitored over time.

### OVERVIEW

Storage system configurations can be tailored to one or more workloads. By tailoring the storage system configuration to the workload(s), the performance of the storage system under the workload(s) can be improved. A storage system workload analyzer can analyze data that is representative of the workload. The analyzer can determine an I/O profile that comprises various characteristics of the workload. The analyzer can determine a configuration that is tailored to the particular I/O profile and implement the configuration in a manner that reduces the impact on users of the storage system.

### BRIEF DESCRIPTION OF THE DRAWINGS

The disclosures may be better understood, and numerous objects, features, and advantages made apparent to those skilled in the art by referencing the accompanying drawings.

FIG. 1 depicts an example storage system with a storage system workload analyzer.

FIG. 2 depicts a flowchart of example operations for monitoring the workload of a storage system.

FIG. 3 depicts a flowchart of example operations for performing a storage system workload analysis.

FIG. 4 depicts a flowchart of example operations for generating an I/O profile.

FIG. 5 depicts an example performance tuning rule look up table for determining a storage system configuration using data from an I/O profile.

FIG. 6 depicts a flowchart of example operations for generating an implementation plan.

FIG. 7 depicts a flowchart of example operations for implementing configuration changes according to an implementation plan.

FIG. 8 depicts an example computer system including a storage system workload analyzer.

### DESCRIPTION OF EXAMPLE ILLUSTRATION(S)

The description that follows includes example systems, methods, techniques, instruction sequences and computer program products that embody techniques of the disclosures herein. However, it is understood that the described examples may be practiced without these specific details. For instance, although examples refer to RAID (“Redundant Array of Inexpensive Disks” or “Redundant Array of Independent Disks”)-based storage systems, other storage system technologies can be used. In other instances, well-known instruction instances, protocols, structures and techniques have not been shown in detail in order not to obfuscate the description.

A storage system workload analyzer can determine a storage system configuration (hereinafter “configuration”) based on the workload of the storage system. To determine the configuration, a storage system component monitors the workload of the storage system. The storage system workload analyzer analyzes the workload to generate an input/output (I/O) profile. The storage system workload analyzer then determines a configuration based, at least in part, on the I/O profile.

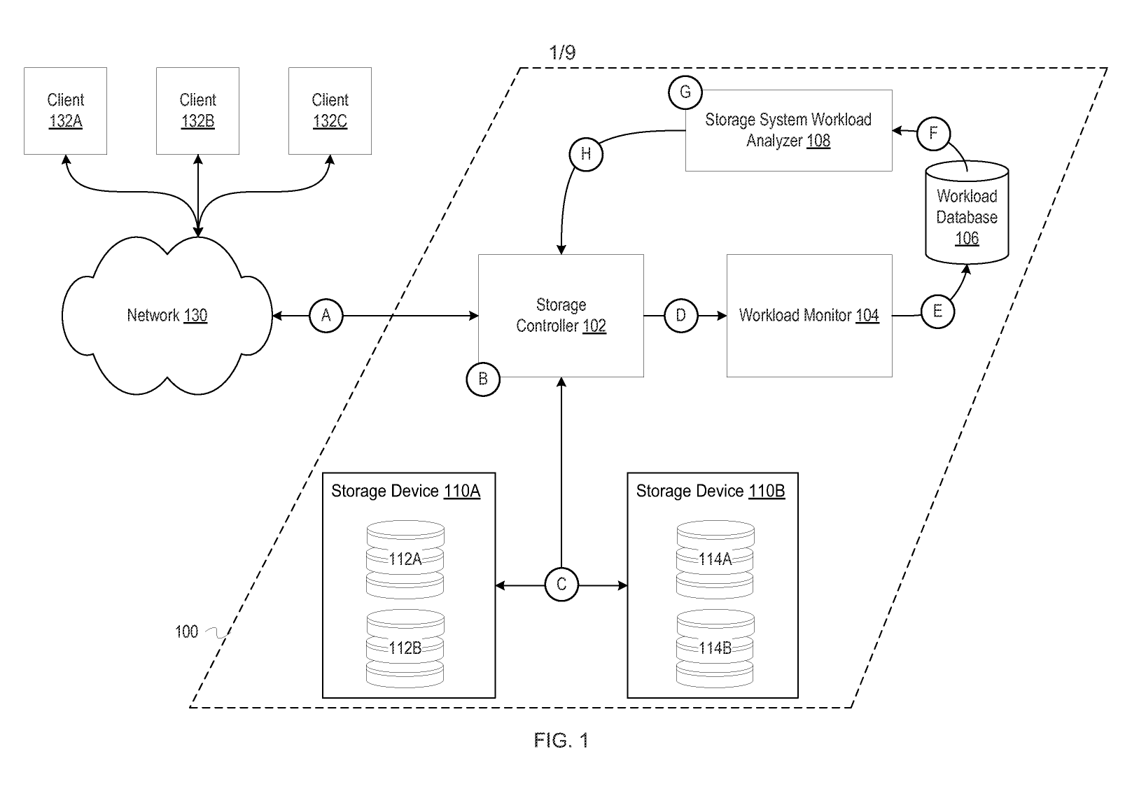

FIG. 1 depicts an example storage system with a storage system workload analyzer. FIG. 1 depicts a storage system 100 including a storage controller 102, a workload monitor 104, a workload database 106, and a storage system workload analyzer (hereinafter “analyzer”) 108. The storage system 100 also includes a pair of storage devices 110A and 110B. Storage device 110A includes disk arrays 112A and 112B. Storage device 110B includes disk arrays 114A and 114B. FIG. 1 also depicts clients 132A-C coupled with the storage controller 102 via a network 130.

At stage A, the storage controller 102 receives I/O operations, such as read and write operations, from the clients 132A-C. The operations can vary based on numerous factors. For example, if the network 130 and the storage system 100 comprise a storage-area network (SAN), read and write operations are block-level operations. If the storage system 100 is a network-attached storage (NAS) system, read and write operations are file-level operations. Regardless of the particular form the operations themselves take, the general result of the I/O operations are reading, writing, and performing other modifications to data located on the storage devices 110A and 110B. The I/O operations can specify a logical volume, data location, file identifier, etc.

At stage B, the storage controller 102 processes the I/O operations received at stage A. The processing of the I/O operations received at stage A can vary. For example, the I/O operations received from the clients 132A-C might reference a logical volume and file. The storage controller 102 can convert the reference to the logical volume and file to an address of a physical location on a disk, such as a disk identifier and block number (or range thereof). Additional examples of operations that might be performed by the storage controller 102 to process the I/O operations include combining multiple I/O operations received from the clients 132A-C into a single I/O operation; splitting a single I/O operation into multiple I/O operations; servicing an I/O operation from cache memory located on the storage controller 102 instead of sending the I/O operation to the storage devices 110A and 110B, etc.

At stage C, the storage controller 102 sends the processed I/O operations to the storage devices 110A and 110B. The storage controller 102 can be communicatively coupled with the storage devices 110A and 110B using iSCSI (Internet Small Computer System Interface), Fibre Channel, or other technology. The processed I/O operations are sent to the particular storage device of the storage devices 110A and 110B that houses the particular physical location associated with the data referenced by the processed I/O operations. Data that appears to be located sequentially to the clients 132A-C can actually be dispersed throughout the disk arrays 112A, 112B, 114A, and 114B. Thus, one I/O operation that references a range of data might be processed into multiple I/O operations, as described above. A storage device that receives one of the processed I/O operations can perform operations to effectuate the processed I/O operation.

At stage D, the workload monitor 104 monitors the operation of the storage controller 102. Monitoring the operation of the storage controller 102 can include monitoring one or more aspects of the storage system operations. For example, the workload monitor 104 might monitor the I/O operations received at stage A, the processing of the I/O operations at stage B, the sending of the I/O operations to the storage devices 110A and 110B at stage C, internal operations of the storage controller 102, etc.

The mechanism by which the workload monitor 104 monitors the operations of the storage controller 102 can vary, as described in detail below. As an example, the workload monitor 104 indicates to the storage controller 102 that workload monitoring should be enabled. In response, the storage controller 102 writes trace data to a file as the trace data is generated. The workload monitor 104 then reads the trace data from the storage controller 102 at periodic intervals.

The trace data can include data about the individual I/O operations received, the various processing operations performed by the storage controller 102, the activity of the storage devices 110A and 110B, etc. For example, the storage controller 102 writes data that can be used to determine the amount of data referenced by each I/O operation. For example, the storage controller 102 can indicate the range of bytes referenced by the I/O operation, the number of blocks, etc. The storage controller 102 also writes statistical data or data that can be used to calculate statistical data. For example, the storage controller 102 can write data indicating the ratio of read operations to write operations (hereinafter “read-to-write ratio”), the total amount of traffic, etc.

At stage E, the workload monitor 104 processes the data generated by the storage controller 102 into workload data and stores the workload data in the workload database 106. The processing of the trace data transforms the trace data into a format that is compatible with the workload database 106. For example, the trace data might include data related to read operations, write operations, and storage controller processing operations intermingled into one file. The workload monitor 104 can extract related data, such as all data related to read operations, and group the related data into a single file, database table, etc. Further, the trace data can include data that is not related to the workload, such as error-related data. While the workload monitor 104 processes the trace data, the workload monitor 104 filters out the non-workload data. Once the trace data is processed into workload data, the workload monitor 104 stores the workload data to the workload database 106. The workload database 106 can be any kind of storage facility for data, such as a relational database, document store, file system, etc.

At stage F, the analyzer 108 reads the workload data from the workload database 106. The technique used to read the workload data from the workload database 106 can vary depending on the workload database 106. For example, if the workload database 106 is a relational database, the analyzer 108 might send a query to the workload database 106. If the workload database 106 is part of a file system, the analyzer 108 might read the workload data from a file. The analyzer 108 might only read a subset of the workload data stored in the workload database 106. For example, the workload database 106 might include workload data from a large period of time while the actual analysis performed by the analyzer 108 might be restricted to a particular time period. Thus, the analyzer 108 might only read a subset of the workload data associated with the particular time period. Similarly, the analyzer 108 might filter out other data that is not relevant to the analysis, such certain I/O operations, errors, etc.

At stage G, the analyzer 108 analyzes the workload data to determine an I/O profile and uses the I/O profile to determine a configuration for the storage system 100. The analyzer 108 creates the I/O profile based, at least in part, on the workload data. The I/O profile can comprise, for example, the read-to-write ratio, the average amount of data referenced by the individual I/O operations (or related metric), whether the I/O operations tend to access sequential data or random data, or whether the I/O operations tend to occur in bursts or at sustained levels. The analysis performed can vary. For example, as described above, the storage controller 102 or the workload monitor 104 might maintain various statistics about the operation of the storage system 100, such as the read-to-write ratio, which can then be included in the workload data. Thus, in some scenarios, the analyzer 108 extracts the relevant data from the workload data. In scenarios in which the various statistics are included as part of the workload data, the analyzer 108 performs the actual analysis that generates the relevant data.

The I/O profile also comprises various non-workload data, including segment size, RAID level, number of drives in a volume group, number of volumes in the volume group, cache settings (such as cache block size and cache flush threshold), and management operation priorities. Thus, the I/O profile comprises not only workload-related data, but other data as well, including data associated with the current configuration. The data that comprises the I/O profile can vary, however. For example, the storage system 100 might not use RAID, in which case the RAID level is not needed. The I/O profile can also comprise data about overall I/O traffic, such as indications of time periods in which the overall I/O traffic is high or low.

Once the I/O profile is determined, the analyzer 108 determines whether a new configuration for the storage system 100 should be determined. For example, if the I/O profile has not changed, the configuration of the storage system 100 should not generally change. However, if data used by the analyzer 108 to determine a configuration based on the I/O profile changes, the analyzer 108 can still determine a configuration even if the I/O profile itself does not change.

If the analyzer 108 determines that a configuration for the storage system 100 should be determined, the analyzer 108 proceeds to determine the configuration based, at least in part, on the I/O profile. To determine the configuration, the analyzer 108 uses the I/O profile, or a subset thereof, to look up a configuration. For example, the data comprising the I/O profile can serve as parameters of a query for a database of configurations or as an input to a lookup table, as described below.

Once the new configuration is determined, the analyzer 108 can compare the new configuration with the current configuration of the storage system 100. If the new configuration and current configuration are the same, no further action is taken. If the new configuration differs from the current configuration, the analyzer 108 generates a configuration change implementation plan (hereinafter “implementation plan”) specifying how and when the new configuration should be implemented.

To generate the implementation plan, the analyzer 108 can take into account the impact that the various configuration changes might have on the storage system 100 as well as I/O traffic trends. For example, implementing some configuration changes, such as modifying the volume configuration, can involve moving the data stored on the storage devices 110A and 110B to different locations. Moving large amounts of data between storage locations can impact the storage system performance. Thus, the analyzer 108 can analyze the I/O traffic patterns to determine when implementation of the configuration changes will result in a less noticeable impact on users (applications or people) using the storage system 100.

Relatedly, the analyzer 108 can determine that various configuration changes can be implemented at different times. For example, the analyzer 108 might determine that a first configuration change can be performed without impacting storage system performance, allowing the first configuration change to be performed immediately. The analyzer 108 might also determine that a second configuration change cannot be performed without impacting storage system performance and, thus, delay the implementation of the second configuration change to a later point in time, such as during a period of low traffic.

Further, the analyzer 108 can estimate the amount of time that the individual configuration changes might take to implement and the impact of implementing multiple configuration changes in parallel. For example, competition for shared resources might cause two configuration changes to take longer to implement if done at the same time instead of sequentially.

Further, some configuration changes might be dependent upon other configuration changes. For example, cache configuration changes might be dependent on volume configuration changes, volume configuration changes might be dependent on RAID configuration changes, etc. Similarly, it might be more efficient to perform some configuration changes subsequent to other configuration changes. For example, a configuration change that increases the performance of the storage system 100 might reduce the amount of time it takes to implement other changes. Thus, the analyzer 108 determines the order in which configuration changes are to be performed based on a variety of factors.

The analysis performed by the analyzer 108 at stage G can result in both a new configuration and an implementation plan for the new configuration. The implementation plan indicates when each of the configuration changes should be made, which serves as indications of when the particular configuration changes can be implemented to minimize impact on normal operation of the storage system 100 as well as indications of dependencies between configuration changes. The timing of the configuration changes can be implicit. For example, the implementation plan might not specify timing data for configuration changes that are to be implemented after the previous configuration change is implemented. Further, even the timing of the initial configuration change might not be indicated. Instead, the implementation plan can be initiated by another process or by a user.

At stage H, the analyzer 108 configures the storage system 100 based on the implementation plan. The implementation of the new configuration can include configuring the storage controller 102, the storage devices 110A and 110B, and any other configurable component of the storage system 100. The analyzer 108 can configure the storage system 100 at one or more times as indicated by the implementation plan, another process, a user, etc.

The specific techniques used to configure the storage system 100 can vary based on different factors, such as the design of the system and components. For example, the analyzer 108 may be able to communicate directly with some storage system components, such as the storage controller 102. However, the analyzer 108 might not be able to communicate directly with some storage system components, such as the storage devices 110A and 110B. Thus, the analyzer 108 can communicate configuration changes directly to some components and through intermediate components. For example, the analyzer 108 might communicate configuration changes for the storage devices 110A and 110B to the storage controller 102, which then communicates or otherwise implements the configuration changes on the storage devices 110A and 110B.

Further, in some scenarios, the analyzer 108 might not implement any of the configuration changes. Instead, the implementation plan generated by the analyzer 108 can be formatted to be compatible with another component that actually implements the configuration changes. For example, the analyzer 108 might transmit the implementation plan itself to the storage controller 102, which then implements the actual configuration changes.

While the workload monitor 104, workload database 106, and analyzer 108 are depicted as individual components, one or more of the aforementioned components can be combined with each other or with another storage system component. For example, the workload monitor 104, the workload database 106, and the analyzer 108 can be implemented as part of the storage controller 102 or as part of one of the clients 132A-C. Or, as another example, the workload monitor 104 can be implemented as part of the storage controller 102, while the workload database 106 and the analyzer 108 are implemented as part of a storage system administration system located on one of the clients 132A-C.

As mentioned above at stage D, the technique(s) used to monitor the workload can vary. For example, as described above, the storage controller 102 can be implemented to write trace data which includes data that can be used to generate the workload data. The workload monitor 104 can also be implemented to monitor the workload similar to a network monitor. For example, the workload monitor 104 connects to the storage controller 102 allowing I/O traffic received or transmitted by the storage controller 102 to also be sent to the workload monitor 104.

The workload monitor 104 can also be implemented to use data from one or more different sources. For example, as described above, the I/O operations received by the storage controller 102 can differ from the I/O operations sent by the storage controller 102 to the storage devices 110A and 110B. Thus, the workload monitor 104 can be implemented to monitor the workload based on the I/O operations received by the storage controller 102 and the I/O operations sent to the storage devices 110A and 110B. The data relevant to the workload monitor 104 can vary, and thus the workload monitor 104 can vary accordingly. The location of the workload monitor 104 can vary accordingly as well. For example, while the workload monitor 104 is depicted as receiving data from the storage controller 102, the workload monitor 104 can be positioned such that the workload monitor 104 receives the I/O operations at stage A. The workload monitor 104 can then monitor the workload and forward the I/O operations to the storage controller 102.

While the stages depicted in FIG. 1 are depicted as individual stages occurring in sequence, some or all of the stages can occur at least partially in parallel. For example, the I/O operations depicted at stages A and B are part of the normal operation of the storage system 100, and thus may occur at any point in time, including in parallel with at least stages D-H. In particular, because the I/O operations depicted at stage A, stage B, or stage C are the operations being monitored by the workload monitor 104, the operations depicted at stage D are generally performed in parallel with stages A and B. Similarly, the analysis operations depicted at stage G and H can occur at the same time as the operations depicted at stages A-E.

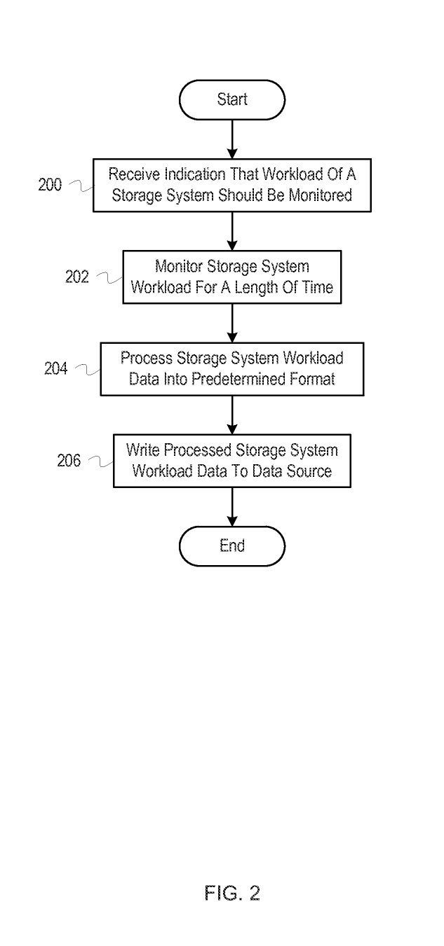

FIG. 2 depicts a flowchart of example operations for monitoring the workload of a storage system. The operations depicted in FIG. 2 can be performed by a workload monitor, such as the workload monitor 104 depicted in FIG. 1, or any other component that embodies functionality similar to the workload monitor 104.

At block 200, a workload monitor receives an indication that the workload of a storage system should be monitored. The indication can be received from another component, such as an operating system, software process, etc. A user can initiate the indication by choosing a particular option on a user interface. The indication can also come from the workload monitor itself. For example, configuration data for the workload monitor might indicate when the workload monitor is to enable monitoring of the storage system workload.

Workload monitoring can be performed for a variety of reasons. For example, workload monitoring can be used for determining the performance level of the storage system, diagnosing errors, etc. Various aspects of the workload might be useful for different uses. For example, if workload monitoring is being used to determine the performance level of the storage system, various statistics about the operation may be useful, such as the length of time taken to write data to a storage device, cache miss rate, etc. If workload monitoring is being used to diagnose the source of errors occurring when writing data, details about the write commands might be useful. Thus, the indication can include data identifying which aspects of the workload should be monitored or the purpose of the monitoring. The workload monitor can utilize the data identifying which aspects of the workload should be monitored or the purpose of the monitoring to dictate the particular aspects of the storage system that are monitored.

The indication can also identify a time period over which to perform the monitoring. For example, the indication can identify a start date/time and an end date/time. The indication might also specify that the workload monitoring is to be performed until the workload monitor receives an indication that the workload monitoring should be stopped. After the workload monitor receives the indication that the workload of the storage system should be monitored, control then flows to block 202.

At block 202, the workload monitor monitors the storage system workload for a length of time. As described above, the length of time can be specified by the indication received at block 200. The length of time can also be an indeterminate length of time (i.e., the monitoring continues until the workload monitor receives an indication that the monitoring should stop). The mechanism used by the workload monitor to monitor the storage system workload can vary, as described above. For example, the workload monitor might indicate to a storage controller that certain operational data should be written to a file accessible to the workload monitor. The workload monitor might connect to a network port on a storage controller and receive data corresponding to the operations of the storage controller through a network connection. The workload monitor might also act as an intermediate component that receives operations from client devices, writes data about the operations, and forwards the operations to a storage controller.

The workload monitoring can include recording data about various operations performed during the operation of the storage system. For example, the workload monitoring can record data about the operations received from client devices, such as whether the operation is a read or write operation, the amount of data associated with the operation, etc. The workload monitoring can also record data about internal processes of a storage controller. For example, the workload monitor can record data that indicates how data specified by client devices in logical volumes is mapped to data in physical volumes by the storage controller. Further, various statistics relating to the operation of the storage system can be recorded as well. For example, the read-to-write ratio and the number of I/O operations received can be monitored during the workload monitoring. After the storage system workload has been monitored for the length of time, control then flows to block 204.

At block 204, the workload monitor processes the storage system workload data into a predetermined format. The processing of the storage system workload data into the predetermined format allows the storage system workload data to be used by other components. Further, processing of the storage system workload data allows additional information to be determined from the raw data. For example, it might not be possible to determine certain statistics about the storage system workload while the workload monitoring is being performed. In particular, determining some statistics in real time might impact the performance of the storage system. Additionally, it might not be possible to determine some statistics until the entire workload, or a specific subset of the workload, has been monitored (e.g., a statistic related to a specific day might not be determinable until all data for the day has been recorded). Thus, during the processing of the storage system workload data into the predetermined format, the workload monitor might also analyze the storage system workload data to produce additional data. After the workload monitor processes the storage system workload data into the predetermined format, control then flows to block 206.

At block 206, the workload monitor writes the processed storage system workload data to a data source. The data source can be a relational database, document store, file, etc. Typically, the workload monitor writes the processed storage system workload data to a location accessible to one or more components that consumes the data at a later point. However, the data can be written to a particular location accessible to the workload monitor and then transferred to a different location accessible to other components.

Although blocks 202, 204, and 206 are depicted as separate, sequential operations, the operations associated with blocks 204 and 206 can be performed at various times, including while the storage system workload is being monitored (block 202). For example, if the workload monitor is to monitor the workload for a day, the workload monitor might process and write the storage system workload data every hour or after a certain amount of data is captured.

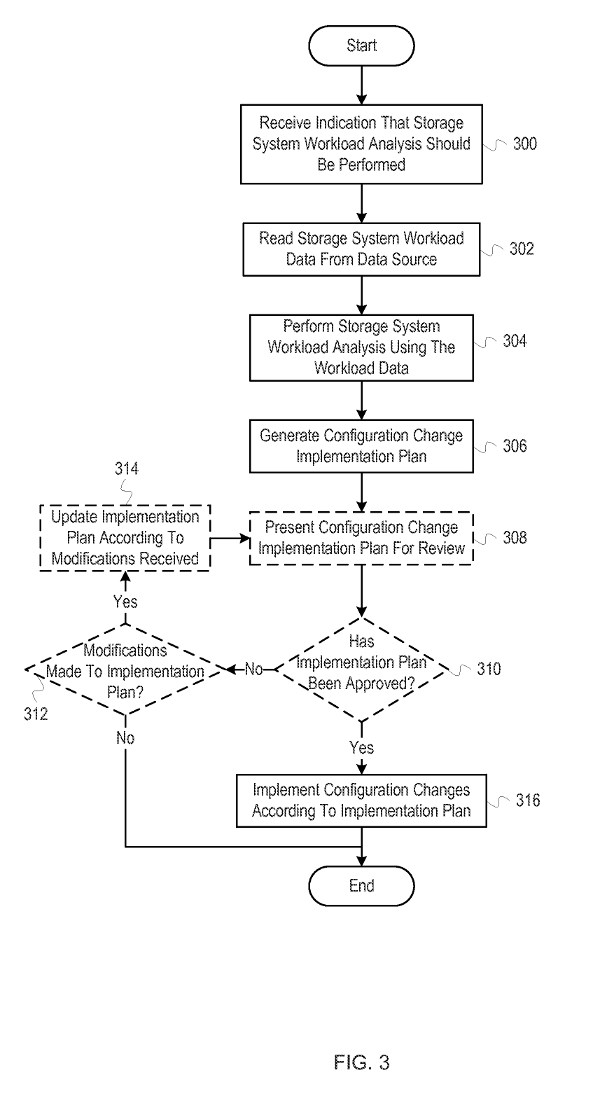

FIG. 3 depicts a flowchart of example operations for performing a storage system workload analysis. The operations depicted in FIG. 3 can be performed by an analyzer, such as the analyzer 108 depicted in FIG. 1, or any other component that embodies functionality similar to the analyzer 108.

At block 300, the analyzer receives an indication that a storage system workload analysis (hereinafter “analysis”) should be performed. The indication can be received from another component, such as an operating system, software process, etc. For example, an operating system (or component thereof) can be configured to cause the analyzer to perform the analysis at regular intervals. Additionally, a user can indicate that the analysis should be performed by choosing a particular option on a user interface. The indication can include a specification of data to use for the analysis, specific factors to take into account, etc. For example, a user might initiate the analysis, specifying that the primary goal of the storage system is reliability and the workload of interest is the workload for the previous week. After the analyzer receives the indication that an analysis should be performed, control then flows to block 302.

At block 302, the analyzer reads the storage system workload data from a data source. The workload data can be the workload data generated by the operations depicted in FIG. 2. The data source can be a relational database, document store, file system, etc. The workload data can be read by querying a subset of the workload data located in the data store. For example, the data store might include workload data from multiple weeks, but the analyzer might query data for the most recent week only. Further, the analyzer might further filter the workload data by specifying specific types of workload data. For example, the analyzer might query workload data that was generated after a storage controller had processed an operation from a client, as opposed to the data of the operation itself. Instead of filtering the data queried, the analyzer might read the entire data set and filter the workload data itself. The analyzer might also perform additional formatting or data conversions on the data. After the analyzer reads the storage system workload data from the data source, control then flows to block 304.

At block 304, the analyzer performs the analysis using the workload data. During the analysis, the analyzer processes the workload data to develop an I/O profile that represents the workload of the storage system. As described above, the I/O profile can include the read-to-write ratio, the amount of data affected or associated with the I/O operations, whether the storage locations accessed are sequential or random, or whether the I/O operations tend to occur in bursts or at sustained levels. If the relevant data is included as part of the workload data (i.e., was predetermined by a storage controller, workload monitor, or other component), the relevant data is extracted from the workload data. If the relevant data is not included as part of the workload data, the analyzer performs the analysis of the workload data to generate the relevant data (discussed below). The specific data relevant to the I/O profile can vary, however.

Once the I/O profile is generated, the resulting I/O profile is further analyzed to determine a new configuration for the storage system. The new configuration is a configuration that takes into account the I/O profile, user preferences, or other factors. For example, the new configuration might indicate a segment size based on the average size of the I/O operations and indicate a particular RAID level based on a user indicating that redundancy is a primary goal. As described above, the new configuration can be determined in a variety of ways, such as querying a database, using a look up table, etc. After the analyzer performs the analysis using the workload data, control then flows to block 306.

At block 306, the analyzer generates an implementation plan. The implementation plan indicates the various changes to be made to the current configuration, when they should be made, and in what order. To generate the implementation plan, the analyzer reads the current configuration and compares the current configuration to the new configuration determined at block 304. The analyzer determines the differences between the current configuration and the new configuration. The configuration settings that are different between the current configuration and the new configuration are the changes that are to be implemented, and thus become the base for the implementation plan.

The analyzer further determines any dependencies between the new configuration settings. For example, a first configuration setting might not be implementable until after a second configuration setting is implemented. Thus, it can be indicated in the implementation plan that the first configuration setting is dependent on the second configuration setting. Dependencies can be indicated implicitly by ordering the configuration settings in the implementation plan based on the dependencies.

The analyzer further determines when the new configuration changes are to be implemented based on the potential impact the change may have on the storage system. The determination can be based on the storage system traffic patterns. For example, if the analyzer determines that implementing a particular configuration change will adversely affect the storage system performance, the analyzer can determine a time in which the load on the storage system is minimal, such as the weekend. The analyzer can further take into account the estimated length of time implementing a particular change will take, among other factors (discussed below).

Blocks 308-314 depict a loop of optional operations for obtaining approval of the implementation plan. Due to the potential impact some configuration changes might have, including making the storage system unavailable for a period of time, operations that allow for user review or modification of the implementation plan can be implemented. If the operations depicted at blocks 308-314 are performed, control flows to block 308 after the analyzer generates the implementation plan at block 306. When the operations depicted at blocks 308-314 are not included, control then flows straight to block 316. Control also flows to block 308 from block 314.

At block 308, the implementation plan is presented for review. The analyzer might present the implementation plan for review on a user interface or send the implementation plan to another component for display. Typically, the implementation plan is presented for review to a user, but this can vary. For example, a user might write a script that receives the implementation plan and automatically approves the implementation plan without user review unless certain configuration changes are indicated. Similarly, the analyzer can include various configurable settings that indicate when the implementation plan should be presented for review. An interface that allows the implementation plan to be presented for review can also allow for modifications to be made to the implementation plan. For example, a user might adjust settings based on the user's preferences or remove configuration changes that might result in the storage system being unavailable for a certain period of time. After the instrumentation plan is presented for review, control then flows to block 310.

At block 310, the analyzer determines whether the implementation plan has been approved. The approval can be received via a user interface, application programming interface (API), etc. If no indication of approval or rejection is received, the default action of the analyzer can be the same as if a rejection was received. If the implementation plan is not approved, control then flows to block 312. If the implementation plan is approved, control then flows to block 316.

At block 312, the analyzer determines whether modifications were made to the implementation plan. The analyzer can be implemented to accept one of three values from an interface used to present the implementation plan for review: approval, rejection, or an indication of modifications. An indication of modifications, for the purpose of approval or rejection acts as a rejection at block 310. If the analyzer received modifications to the implementation plan, control then flows to block 314. If the analyzer did not receive modifications to the implementation plan, the process ends.

At block 314, the analyzer updates the implementation plan according to the modifications received. The analyzer can validate the modifications received to ensure that the implementation plan does not contain any errors. For example, adding a configuration change might also add a dependency that was not included in the modifications. Similarly, the implementation times might need to be adjusted, configuration changes reordered, etc. In general, the operations performed at block 314 are similar to those performed at block 306, but adjusted to remain consistent with the modifications. After the analyzer updates the implementation plan according to the modifications received, control then flows back to block 308.

Control flows to block 316 if it was determined, at block 310, that the implementation plan was approved. Control also flowed to block 316 from block 306 if the optional operations depicted at blocks 308-314 are not performed. At block 316, the analyzer implements the configuration changes according to the implementation plan. The configuration changes can be implemented in a variety of ways, depending not only on the analyzer, but also the other components of the storage system. For example, the analyzer might update a configuration change by modifying a configuration file and causing the configuration file to be reloaded by an associated component. The analyzer might communicate with a component via an API that allows the analyzer to specify configuration changes. The analyzer might indicate the configuration change to an intermediate component that then implements the configuration change. Further, the operation(s) performed at block 316 can be spread out over a period of time. For example, a first configuration change might be implemented immediately, a second might be implemented over night, while a third might be implemented over a weekend. After the analyzer implements the configuration changes according to the implementation plan, the process ends.

Block 306 depicts the analyzer reading the current configuration in order to compare the current configuration with the new configuration. The comparison allows the analyzer to create an implementation plan that only includes configuration settings that change. In some scenarios, however, the analyzer does not perform the comparison; instead, the analyzer includes all configuration settings in the implementation plan.

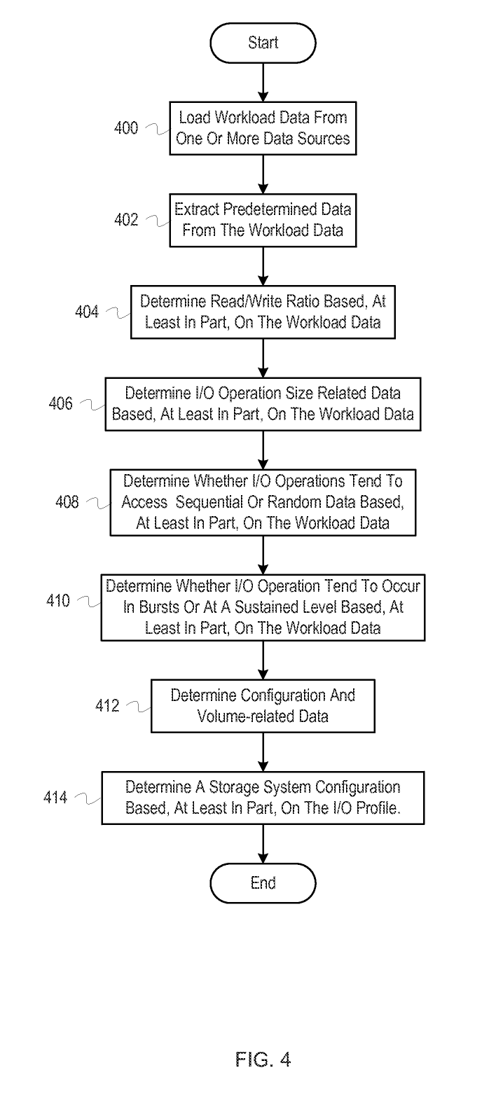

FIG. 4 depicts a flowchart of example operations for generating an I/O profile. The operations depicted in FIG. 4 can be performed by an analyzer, such as the analyzer 108 depicted in FIG. 1, or any other component that embodies functionality similar to the analyzer 108.

At block 400, an analyzer loads workload data from one or more data sources. The data source can be a database, file system, etc. The analyzer can load all available workload data or filter out some portion of the workload data. The filtering can be specified in a query, performed by the analyzer itself, or a combination thereof. For example, the analyzer might query a database for the workload data and specify a date range. The database would then return the workload data for the specified date range, thus excluding data that falls outside of the specified date range. The analyzer might load all available workload data and then iterate through the data entries, discarding any data entries that are not within the desired date range. The analyzer might query for a subset of the data then perform additional filtering itself. The actual data that can be filtered can vary. For example, the analyzer might be able to filter on date, operation type, client, etc. The analyzer might load multiple data sets. For example, a database might include predetermined statistical data in one database table and I/O operations in another database table. The analyzer can query each table separately to retrieve both sets of data. Similarly, the different data sets can be located at different data sources. For example, the I/O operations data might be stored in a database while the predetermined statistical data is stored in a file located within a file system. After the analyzer loads workload data from one or more data sources, control then flows to block 402.

At block 402, the analyzer extracts any predetermined data from the workload data. For example, if the predetermined statistical data is combined with the workload data that includes the I/O operations, the analyzer extracts the predetermined statistical data from the workload data. Extraction of the predetermined data can include parsing the loaded data and searching for indicators associated with the predetermined data. After the analyzer extracts any predetermined data from the workload data, control then flows to block 404.

At block 404, the analyzer determines the read-to-write ratio based, at least in part, on the workload data. To determine the read-to-write ratio, the analyzer can iterate through the I/O operations in the workload data. As the I/O operations are iterated through, the analyzer maintains a count of the read operations and a count of the write operations. After iterating through all of the I/O operations, the analyzer computes the read-to-write ratio according to the formula depicted in Equation 1.

$$\frac{\# of Read Operations}{\# of Write Operations} \qquad Equation 1$$

The analyzer can also determine the ratio of read operations to the total number of read and write operations using the formula depicted in Equation 2.

$$\frac{\# of Read Operations}{\# of Read Operations + \# of Write Operations} \qquad Equation 2$$

The ratio of write operations to the total number of read and write operations can be determined by substituting the number of write operations for the number of read operations in the numerator of Equation 2. Other variations of the read-to-write ratio can be determined if useful for a particular scenario. For example, the read-to-write ratio can be based on the quantity of data transferred as opposed to the number of actual operations. Additionally, the relevant read and write operations can vary. For example, read and write operations can apply to user data, metadata, or other kinds of data. In some instances, the read and write operations used to calculate the read-to-write ratio might be restricted to read and write operations that apply to a particular type of data (or combinations of types of data). The read and write operations used to calculate the read-to-write ratio can vary based on other attributes as well, such as the target volume, the originating client, etc. After the analyzer determines the read-to-write ratio based, at least in part, on the workload data, control then flows to block 406.

At block 406, the analyzer determines data related to the size of the I/O operations based, at least in part, on the workload data. The specific data determined by the analyzer can vary based on what particular data is deemed useful (by a system designer, for example), based on the I/O operation implementation, based on differences between workload data, etc. For example, the analyzer might determine the average amount of data referenced by the I/O operations. The determination of the average amount of data referenced by an I/O operation varies based on the I/O operations themselves. For example, in a SAN-based storage system, the I/O operations typically refer to specific range of logical blocks (of a particular logical volume). To determine the average amount of data referenced by an I/O operation that specifies a range of logical blocks, the analyzer multiplies the logical block size by the number of blocks in the specified range. However, in a NAS-based storage system, the I/O operations typically refer to files (or portions thereof), which can include specifying a range of bytes. To determine the average amount of data referenced by an I/O operation that specifies a range of bytes, the analyzer merely determines the number of bytes in the range.

The workload data can also vary. For example, instead of indicating the raw I/O operation data, such as the range of blocks specified in the I/O operation, the workload monitor might determine the amount of data referenced. The workload monitor might then write an indication of the I/O operation with the amount of data referenced instead of the range of blocks. Thus, the operations performed by the analyzer can be adapted based on the workload data.

As mentioned above, the specific data related to the size of the I/O operations determined can vary based on what data is determined to be relevant. For example, consider a scenario in which the minimum amount of data that can be read or written is a block of four kilobytes. A client thus writes a block of four kilobytes, even if only two kilobytes of data actually changed. Thus, the minimum block size masks the actual amount of data affected by the operation. In order to get a more accurate idea of the amount of data being written, the workload data might indicate, or the analyzer might determine, the actual amount of data that was modified. Thus, the workload data might specify that two kilobytes of the four kilobyte block were modified. Additionally, the analyzer might use values other than the average. For example, the analyzer might determine a value based on the standard deviation of the I/O operation sizes. The analyzer might determine a value that is greater than the amount of data referenced by a certain percentage of the I/O operations. For example, if ninety percent of the I/O operations reference four kilobytes of data or less, the analyzer can use four kilobytes as the size related data. Other relevant metrics might be used as well. After the analyzer determines data related to the size of the I/O operations based, at least in part, on the workload data, control then flows to block 408.

At block 408, the analyzer determines whether the I/O operations tend to access sequential or random data based, at least in part, on the workload data. To determine whether the I/O operations tend to access sequential or random data, the analyzer can analyze the data locations referenced by sequential I/O operations. One technique that can be used to determine how sequential the accesses are by grouping together sequential I/O operations that access sequential data that is within a certain range of the previous I/O operation. In other words, I/O operations that access sequential data (even if small gaps are present, as long as the gaps are below a particular threshold) are grouped together. The longer the groups are, the more sequential the I/O operations tend to be. If the I/O operation references tend to jump around, either by being too far past the previous I/O operation or accessing data located at a lower block number, the group size will be smaller. Similarly, the specific thresholds that result in a determination that the I/O operations tend to access sequential or random data (or a mixture thereof) can vary as well.

Which I/O operations are used for determining whether the I/O operations tend to access sequential or random data can vary as well. For example, when a storage controller receives an I/O operation that indicates a logical volume and logical blocks, the storage controller translates the logical volume and logical blocks into a physical location. The physical location of data might have no correspondence with the logical blocks. In other words, where a range of logical blocks on a logical volume appears to be located in sequential locations on disk, they may, in fact, be spread over disks, storage devices, etc. While the analyzer will typically use the I/O operations that are unmapped (i.e., refer to logical volumes/blocks), the analyzer can use the physical locations instead.

Similar to the analyses described above, the analysis can vary based on the I/O operation implementations. Further, the size related data determined at block 406 can be used to determine whether the I/O operations tend to access sequential or random data. In other words, the amount of data referenced by the I/O operations might serve as a proxy for how sequential the I/O operations tend to be. After the analyzer determines whether I/O operations tend to access sequential or random data based, at least in part, on the workload data, control then flows to block 410.

At block 410, the analyzer determines whether I/O operations tend to occur in bursts or at a sustained level based, at least in part, on the workload data. Different uses of storage systems can result in different traffic patterns. For example, a storage system might store large data files that are processed in batches. When the data files are processed, the storage system will typically receive a large number of I/O operations as the data files are read into memory. When the data files are not being processed, on the other hand, the storage system might only receive a small number of I/O operations. A storage system that is used for storing backups might see a steady number of I/O operations over a much longer period of time while the backups are being created.

The analyzer can determine whether I/O operations tend to occur in bursts or at a sustained level by determining the volatility of the I/O traffic, determining the rate of increase/decrease in traffic volume, comparing the minimum and maximum volume levels, etc. Similar to the thresholds used for the read-to-write ratio, the thresholds that qualify the I/O operations as occurring in bursts or at sustained levels can vary. The thresholds can also be configurable values. After the analyzer determines whether the I/O operations occur in bursts or at a sustained level, control then flows to block 412.

At block 412, the analyzer determines configuration and volume-related data. The configuration and volume-related data can be determined by querying various components of the storage system. For example, the analyzer can query a storage controller to determine cache configuration data, such as cache block size, cache settings, and cache flush thresholds. The storage controller or storage devices can be queried to determine volume-related data, such as the segment size, RAID level, number of drives within a volume group, number of volumes within a volume group, etc. The analyzer can also determine data related to the operation of the storage system, such as the current status of the components, priorities associated with various processes, volume reconstruction data, etc. After the analyzer determines configuration and volume-related data, control then flows to block 414.

At block 414, the analyzer determines a configuration based, at least in part, on the I/O profile. The I/O profile comprises the data determined above, including any predetermined data, the read-to-write ratio, the I/O operation size-related data, tendency of I/O operations to access sequential or random data, tendency of the I/O operations to occur in bursts or at sustained levels, and the configuration and volume-related data. The I/O profile can include additional data or omit some of the aforementioned data depending on the relevance of the data. Once the I/O profile data is determined, the analyzer can utilize the I/O profile data to determine a configuration.

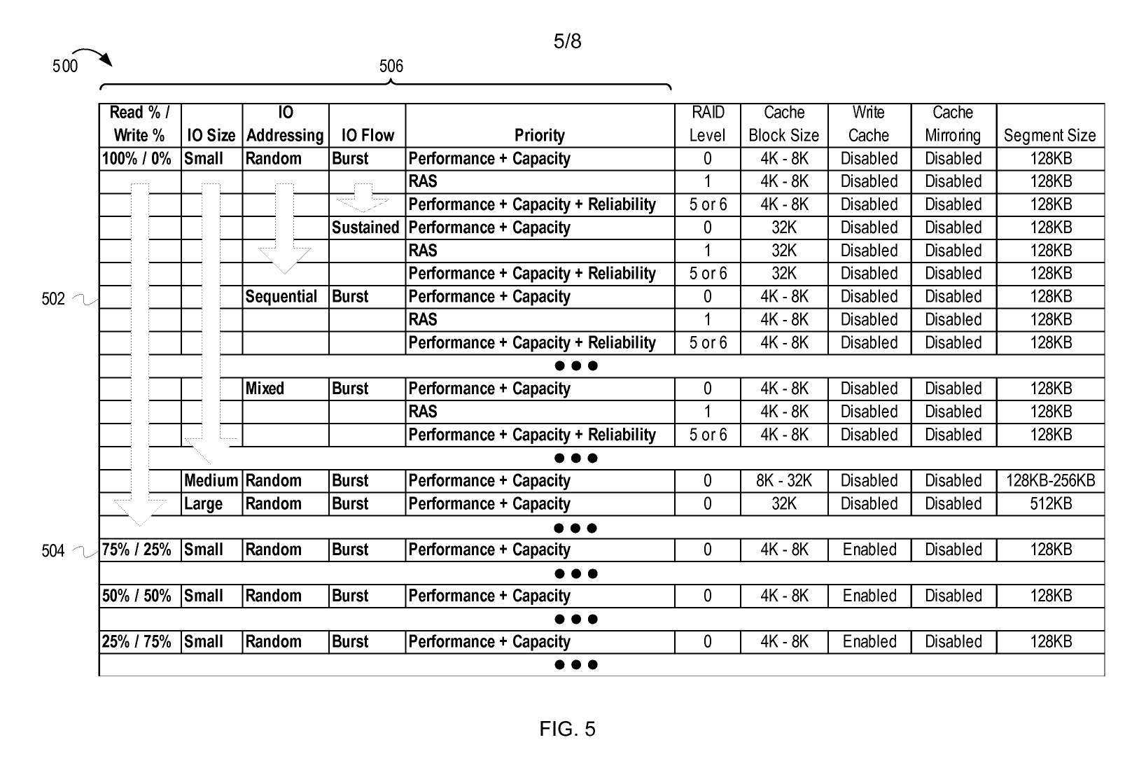

To determine the configuration, the analyzer can use the I/O profile data as parameters in a database query, indices into a look up table, etc. For example, the analyzer can query a database for configurations that are associated with values that match some or all of the I/O profile data. A sample look up table is depicted below in FIG. 5.

Further, the analyzer can dynamically determine a configuration by determining the impact various configuration options might have on the storage system based on the I/O profile data. In other words, instead of looking up a predetermined, static configuration, the analyzer can create a configuration for the storage system. For example, the analyzer can access data indicating the expected impact of possible configuration changes based on the I/O profile data. The analyzer can then generate permutations of the possible configuration changes to determine which set of configuration changes will provide the best outcome. The data used to determine the impact that various configuration options might have on the storage system can be based on actual historical data from the storage system and other storage systems. After the analyzer determines the configuration based, at least in part, on the I/O profile, the process ends.

FIG. 5 depicts an example performance tuning rule look up table for determining a configuration using data from an I/O profile. FIG. 5 depicts a performance tuning rule look up table (hereinafter “table”) 500. The first five columns 506 are indices associated with an I/O profile. All other columns are storage configuration settings. Each row, thus, corresponds to a particular configuration indexed by the I/O profile data. Only a subset of the rows is depicted. The arrows indicate that the value at the tail of the arrow applies to all rows until the value changes. For example, the value “100%/0%” in the “Read %/Write %” column is the read-to-write ratio for all rows until the value changes to “75%/0%”.

The index columns are labeled “Read %/Write %”, “IO Size”, “IO Addressing”, “IO Flow”, “Priority”. The “Read %/Write %” corresponds to the read-to-write ratio determined above. The first value in the “Read %/Write %” column indicates the percentage of I/O operations that are read operations while the second value indicates the percentage of I/O operations that are write operations. For example, “75%/25%” indicates that seventy-five percent of the I/O operations are read operations and that twenty-five percent of the I/O operations are write operations.

The “IO Size” column corresponds to the size of the I/O operations. For example, as described above, the size of the I/O operations might be the average amount of data referenced by the I/O operations. The cell values “Small”, “Medium”, and “Large” can correspond to threshold values. For example, “Small” might correspond to I/O operations of less than or equal to eight kilobytes; “Medium” might correspond to I/O operations of between eight kilobytes and 128 kilobytes; and “Large” might correspond to I/O operations of greater than or equal to 128 kilobytes. The specific threshold values can vary, however, and can be based on various factors, such as storage system design, experimental testing, etc. For example, as described above, a controller can process I/O operations coming from a client by breaking the I/O operations into smaller I/O operations that are then sent to the storage devices. If the analysis uses the processed I/O operations, the threshold values might vary. For example, the threshold corresponding to “Small” might be 512 bytes. The threshold values can also be configurable.

The “IO Addressing” column corresponds to whether the I/O operations tend to access sequential or random data. The cell values “Random”, “Sequential”, and “Mixed” correspond to threshold values. For example, if more than seventy-five percent of the I/O operations are grouped into sequential accesses of a predetermined length, the I/O operations might meet a threshold for being sequential. The specific threshold values can vary and can be based on various factors, such as storage system design, experimental testing, etc. The threshold values can be configurable.

The “IO Flow” column corresponds to whether the I/O operations tend to occur in bursts or at a sustained level. The cell values “Burst” and “Sustained” correspond to threshold values. For example, if the standard deviation of the I/O operation volume is within a certain percentage of the mean volume, the I/O operations might meet a threshold for being sustained. If the standard deviation of the I/O operation volume is not within a certain percentage of the mean volume, the I/O operations might meet a threshold for occurring in bursts. The specific threshold values can vary and can be based on various factors, such as storage system design, experimental testing, etc. The threshold values can be configurable.

The “Priority” column corresponds to user preferences for the balancing performance, capacity, and reliability. The cell values “Performance”, “Capacity”, and “Reliability” correspond to user preferences that vary depending on the goal/use of the storage system. Storage systems can be performance, capacity, or reliability-oriented. For example, a storage system configured at RAID Level 0 stripes data across multiple disks, but offers no redundancy. As another example, a storage system configured at RAID Level 1 mirrors data across multiple disks, offering both performance and reliability while sacrificing capacity. The particular preference can be configured by the user or can be determined by analyzing the configuration of the storage system.

The storage configuration settings are labeled “RAID Level”, “Cache Block Size”, “Write Cache”, “Cache Mirroring”, and “Segment Size”. The “RAID Level” column corresponds to the RAID level that the storage system volumes are configured at. For example, the cell value “0” corresponds to RAID level 0, the cell value “1” corresponds to RAID level 1, etc. The RAID level configuration setting generally corresponds to the “Priority” user preference. For example, if the user preference for priority is performance, the RAID level is RAID level 0. If the user preference for priority is performance and reliability, the RAID level is RAID level 1. If the user preference for priority is performance, reliability, and capacity, the RAID level is RAID level 5 or 6.

The “Cache Block Size” column corresponds to the size of each cache block (similar to a cache line) measured in kilobytes. A cache block is, essentially, the unit of data transferred to and from the cache. In other words, data is transferred between the cache and the backing store in sizes equal to the cache block size. The cache block size will generally vary with the size of the I/O operations. Consider a scenario in which most I/O operations accessed (read or write) four kilobytes worth of data and the cache block size is thirty-two kilobytes. If a read operation references a location that is not in the cache, the data at the referenced location is loaded into the cache from the backing store. However, because the cache block size is thirty-two kilobytes, the thirty-two kilobytes of data that includes the four kilobytes referenced are loaded, which is twenty-eight kilobytes greater than the operation accessed. However, if the cache block size is four kilobytes, only the four kilobytes referenced are transferred. The penalty becomes even worse if the read operation references data that spans cache block boundaries (resulting in two cache blocks being loaded for the same read operation).

In general, larger cache block sizes provide better performance, particularly when the I/O size is also large. The performance also varies based on whether the I/O operations tend to access data randomly or sequentially. For example, if the I/O size is four kilobytes and the workload accesses data randomly, a cache block size of thirty-two kilobytes, which is the upper range in the current example, will generally provide the best performance. On the other hand, if the I/O size is four kilobytes and the workload accesses data sequentially, a smaller cache block size, such as four kilobytes, will generally provide the best performance.

The “Write Cache” column indicates whether the write cache is enabled. Whether the write cache is enabled generally depends on the write ratio of the read-to-write ratio. For example, if there are no write operations, then the write cache serves no purpose. Even if there are a small number of write operations, the overhead resulting from enabling the write cache may surpass any performance benefits. In the table 500, anything that has a write ratio of twenty-five percent or greater has the write cache enabled. This can vary with the granularity of the read-to-write ratio index. For example, if the read-to-write ratio index included read-to-write ratios based on increments/decrements of ten percent, instead of twenty-five percent, some write ratios between twenty-five percent and zero percent might have the write cache enabled.

The “Cache Mirroring” column corresponds to whether cache mirroring is enabled. Cache mirroring functionality is available when multiple storage controllers are used for redundancy within a storage system. Although storage controllers can back up the contents of their cache onto non-volatile media, if a storage controller fails before the contents of their cache is written onto the non-volatile media, the cache might not be recoverable. Thus, when redundant storage controllers are used, a storage controller (generally a primary storage controller) can mirror the contents of its cache to another storage controller. The mirroring of the cache can be done more frequently and can take less time than writing the contents of the cache to non-volatile memory, resulting in lower chances of data loss. However, cache mirroring can reduce performance of the storage controller. Thus, whether cache mirroring is enabled is typically related to the priority of the storage system. If reliability is not a priority, then the write cache is generally disabled, maximizing performance.

The “Segment Size” is the size of the RAID segment (or similar concept used by the particular technology). The segment size, more specifically, is the amount of data written to one disk in an array before writing data to the next disk. For example, if the segment size is 128 kilobytes and 256 kilobytes were written, 128 kilobytes of data is written to a first disk and 128 kilobytes of data is written to a second disk. The segment size generally corresponds to the size of the I/O operations, similar to the cache block size.

To utilize the table, an analyzer (or other component) extracts the data from the I/O profile. The data is then used as an index into the table. As a first example, an I/O profile indicates that the read-to-write ratio is 100% reads. The analyzer then matches the read-to-write ratio with the same value in the “Read %/Write %” column, which can be any of the first fourteen rows. The I/O profile also indicates that the I/O size is “small” and matches the I/O size with the same value in the “I/O Size” column, which can be any of the first twelve rows. The I/O profile also indicates that the I/O addressing reached the threshold for “sequential”, the I/O flow reached the threshold for “burst”, and that the priority is performance and capacity. The analyzer thus selects the configuration corresponding to row 502, which is indexed by values that match the data of the I/O profile. As a second example, if the I/O profile indicated that the read-to-write ratio was seventy-five percent reads (and twenty-five percent writes), the I/O size was small, the I/O addressing was random, the I/O flow is burst, and the priority is performance and capacity, the analyzer selects the configuration corresponding to row 504.

The table 500, as mentioned above, is a sample table. The specific metrics and other values used for the indices can vary in accordance with their relevance to a particular scenario. For example, some tables might not have the same indices shown in FIG. 5 and might have others not described. Similarly, additional storage configuration settings can be used if relevant while some or all of the depicted storage configuration settings might not be used if not relevant. For example, if the I/O operations tend to access sequential data, the storage system might be configured to load additional data into the cache even before an additional write operation is received. For example, if a read operation indicates a first block of data, instead of loading the first block of data into a cache, the storage system might load the first, a second, and a third block of data into the cache. Thus, a configuration setting corresponding to the aforementioned functionality might be added to the table 500.

Some additional configuration settings that might be relevant are the maximum number of drives in a volume group, maximum number of volumes per volume group, volume type (e.g., dynamic disk pool), drive type (e.g., hard drive or flash drive), etc. Further, the table 500 can vary in many other ways as well. For example, the granularity of the indices can be increased, the thresholds can vary, etc.

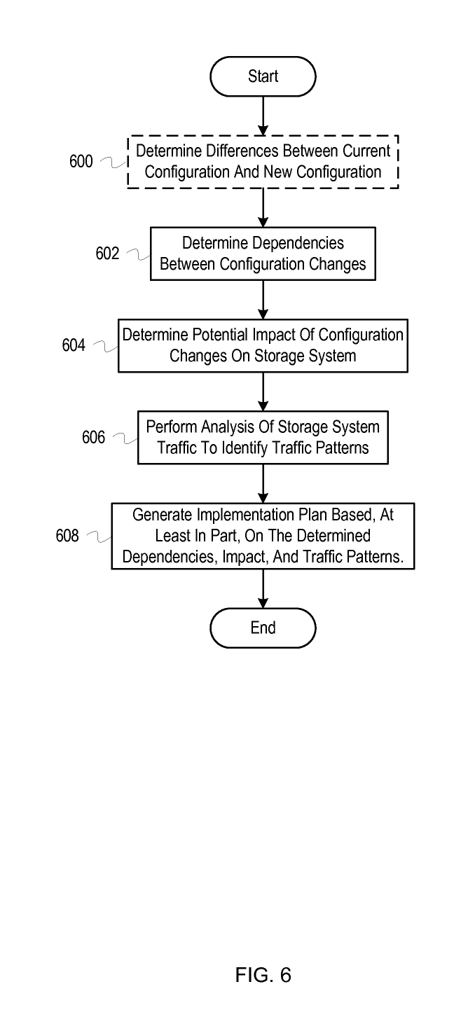

FIG. 6 depicts a flowchart of example operations for generating an implementation plan. The operations depicted in FIG. 6 can be performed by an analyzer, such as the analyzer 108 depicted in FIG. 1, or any other component that embodies functionality similar to the analyzer 108.

At block 600, the analyzer optionally determines the differences between the current configuration and new configuration. To determine the differences between the current configuration and the new configuration, the analyzer first determines the current configuration. The mechanisms used to determine the current configuration can vary. For example, the configuration data might be in a single location, allowing the analyzer to read or otherwise access the configuration data from the single location. Further, the analyzer might query each component for the respective component's configuration data. In general, the mechanism(s) used by the analyzer to determine the current configuration will vary with the capabilities of the associated components. The analyzer might only determine a subset of the current configuration that is related to the new configuration. In other words, the analyzer might only determine the current configuration for the settings indicated in the new configuration.

Once the current configuration is determined, the current configuration can be compared to the new configuration. The analyzer can look, in the current configuration, for each configuration setting indicated in the new configuration. Once the analyzer finds a configuration setting in the current configuration, the analyzer compares the current value(s) with the value(s) indicated in the new configuration for that particular configuration setting. If the value(s) is/are the same, there is no change between the current configuration and the new configuration, thus allowing the particular configuration setting to be discarded from the new configuration (or otherwise indicating that the change will not be implemented). If the value(s) is/are different, the new configuration will result in the modification of the particular configuration setting.

Overwriting configuration settings with the same value might not result in any side effects. In other words, components can determine whether a configuration setting is merely overwritten with the same value or updated to a different value. However, if the analyzer can access the values associated with the current configuration, determining the differences between the current configuration and the new configuration can decrease the possibility of errors and increase the performance of the implementation changes. After the differences between the current configuration and the new configuration have been determined, control then flows to block 602.

At block 602, the analyzer determines dependencies between configuration changes. As described above, a dependency occurs when a first configuration change should be made before a second configuration change. In some instances, a dependency can be a required dependency. A required dependency follows from a scenario in which the first configuration change must be made prior to the second configuration change or when the first configuration change might invalidate the second configuration change if made out of order. For example, assume a scenario in which the first configuration change is changing the maximum number of logical volumes per volume group from two to one and the second configuration change is the actual creation of logical volumes. If the logical volumes were created first, the volume groups might have two logical volumes. Thus, when the maximum number of logical volumes per volume group is changed, the logical volumes exceed the value.

In some instances, a dependency can be a “suggested” dependency. A suggested dependency follows from a scenario in which making a first configuration change can have a positive or negative impact on a second configuration change. For example, consider a scenario in which a first change significantly increases the performance of the storage system and implementation of a second change results in a large number of I/O operations. By making the first change before the second change, the second change might take less time. The reverse is true as well. If the first change significantly reduces the performance of the storage system, it would be preferable to perform the first change after any change that results in a large number of I/O operations (if possible).

The determination of dependencies allows the analyzer to order the configuration changes properly. The required dependencies form the base order of the configuration changes. Suggested dependencies can be factored in as long as they do not violate the required dependencies. Independent configuration changes can then be placed according to other factors, such as traffic patterns and impact (discussed below). To determine the actual dependencies, the analyzer can query a database, load a dependency tree, read a configuration file, etc. After the analyzer determines the dependencies between configuration changes, control then flows to block 604.

At block 604, the analyzer determines the potential impact of the configuration changes on the storage system. The impact on the storage system includes factors such as storage system availability, storage system performance, potential loss of data, etc. Determining the impact on the storage system can allow the analyzer to make decisions about when certain changes should be made. For example, if the implementation of a particular configuration change would result in the storage system being unavailable, the analyzer can warn an administrator, allowing the administrator to coordinate with users of the storage system. If the implementation of a particular configuration change would result in degradation of storage system performance, the analyzer might schedule the implementation such that the implementation coincides with a period of low traffic. The performance impact can be specified in a database, a configuration file, determined from historical data, etc. Determining the potential impact of the configuration changes can also include determining, or otherwise estimating, how long it would take to fully implement each change. After the analyzer determines the potential impact of the configuration changes on the storage system, control then flows to block 606.

At block 606, the analyzer performs an analysis of the storage system traffic to identify traffic patterns. The storage system traffic patterns can be used to schedule the implementation of the configuration changes. For example, if a particular configuration change was determined, at block 604, to significantly reduce the performance of the configuration, the analyzer might schedule the implementation of the change to coincide with a low traffic period. The analyzer can also factor in the length of time implementation of a particular change might take. For example, the analyzer might determine that the storage system has a nightly period of low activity lasting eight hours and a forty-eight hour period of low activity every weekend. If implementing a particular change might degrade storage system performance for twelve hours, the analyzer can schedule the implementation of the change for the weekend.

The techniques used to identify storage system traffic patterns can vary. For example, the analyzer can identify traffic patterns by determining the amount of storage system traffic at various time periods and comparing data across the time periods. For example, the analyzer might analyze workload data to determine the amount of storage system traffic (using metrics such as I/O operations per second, data transferred, etc.) every five minutes over a period of several weeks. The analyzer can assign values indicating the traffic level (e.g., “high”, “medium”, and “low”) if the traffic is over associated thresholds. The analyzer can then aggregate consecutive time periods that have the same traffic levels to determine ranges of time that have particular traffic levels. The subsequent ranges can be compared between longer time period (e.g., weeks) to determine repetition of traffic patterns. As another example, the traffic patterns can be determined by a user and entered into an interface and saved to a file that can be read by the analyzer. After the analyzer performs the analysis of the storage system traffic to identify traffic patterns, control then flows to block 608.

At block 608, the analyzer generates an implementation plan based, at least in part, on the previously determined dependencies, impact, and traffic patterns. If there are no dependencies, no timing considerations, etc., the implementation plan might only indicate the configuration changes to be made. If dependencies are a factor, then the implementation plan indicates, implicitly or explicitly, the order in which the changes are implemented. The order can be specified based on explicit start times for each configuration change or by beginning the implementation of configuration changes after completion of the prior one. If there are timing considerations, the implementation plan can indicate the times at which implementation of one or more configuration changes is to begin. Additional data can be included, such as individual operations to perform in order to implement each change, component information, etc. The implementation plan can be generated in a predetermined format that is compatible with other components. After the analyzer generates the implementation plan, the process ends.

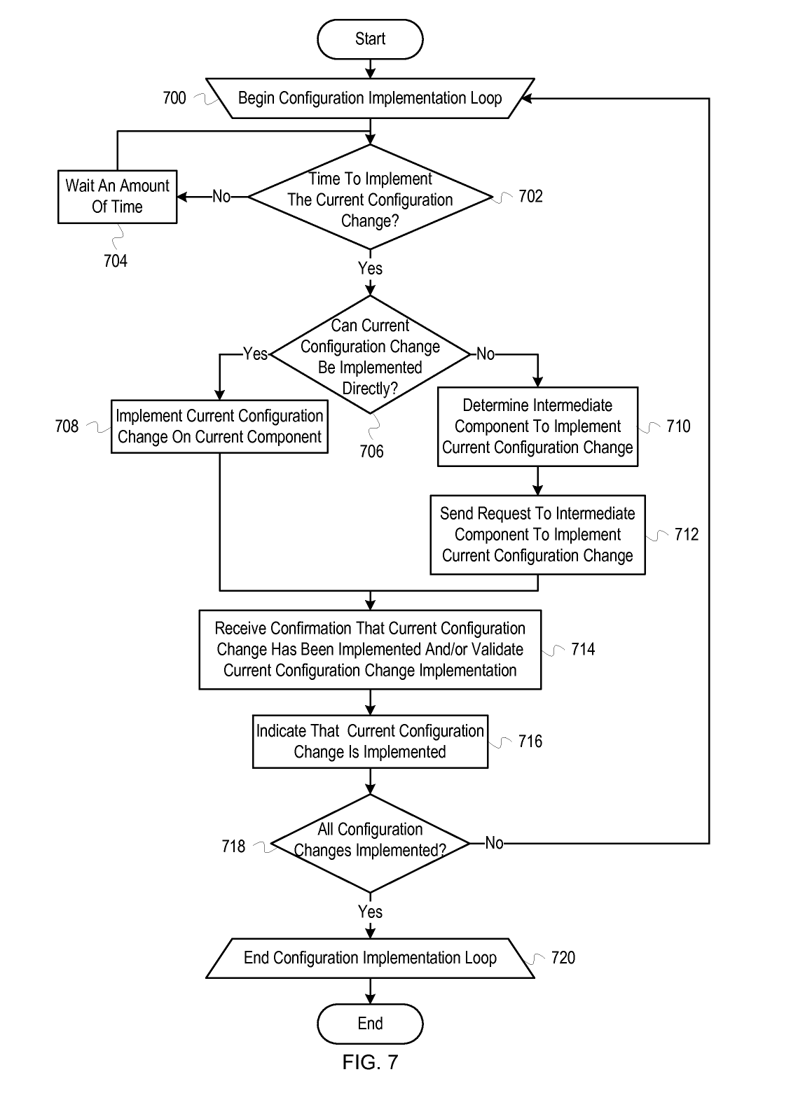

FIG. 7 depicts a flowchart of example operations for implementing configuration changes according to an implementation plan. The operations depicted in FIG. 7 can be performed by an analyzer, such as the analyzer 108 depicted in FIG. 1, or any other component that embodies functionality similar to the analyzer 108.

At block 700, a configuration implementation loop begins. During the configuration implementation loop, the analyzer iterates through the implementation plan and implements the various configuration changes as indicated. The analyzer initiates the loop by selecting the first configuration change from the implementation plan. The first configuration change becomes the current configuration change for the purposes of the configuration implementation loop. On each subsequent iteration, the analyzer selects the next configuration change in the implementation plan, which becomes the current configuration change. Each configuration change is associated with a component. For example, a particular configuration change might be made to a storage controller. The component associated with the current configuration change is the current component. After the configuration implementation loop begins, control then flows to block 702.

At block 702, the analyzer determines whether it is time to implement the current configuration change. To determine whether it is time to implement the current configuration change, the analyzer determines whether the current configuration change is associated with a particular time. For example, the indication of the current configuration change in the implementation plan can indicate the implementation time. If an implementation time is indicated for the current implementation, the analyzer compares the indicated time with the current time. If the indicated time has passed, it is time to implement the current configuration change. If no time is indicated, the current configuration change can be implemented at any time and is treated the same as if a past implementation time was indicated. If the analyzer determines that it is not time to implement the current configuration change, control then flows to block 704. If the analyzer determines that it is time to implement the current configuration change, control then flows to block 706.

At block 704, the analyzer waits an amount of time. The amount of time the analyzer waits can be predetermined. For example, the analyzer might wait a minute, ten minutes, etc. The analyzer can also determine an amount of time to wait based on the indicated implementation time associated with the current configuration change. For example, if the indicated implementation time associated with the current configuration change is thirty minutes in the future, the analyzer might wait thirty (or thirty-one) minutes. The time period that the analyzer waits can be determined by another component. For example, the analyzer might wait until the analyzer receives an indication from a scheduler component that the analyzer should continue. After the analyzer waits the amount of time, control then flows back to block 702.

Control flowed to block 706 if it was determined, at block 702, that it is time to implement the current configuration change. At block 706, the analyzer determines whether the configuration change can be implemented by the analyzer directly instead of using an intermediate component. Whether the analyzer can implement the configuration change directly can be indicated in the implementation plan. For example, each configuration change might include a flag indicating that the configuration change can be implemented directly. Further, the storage system can be implemented such that the analyzer either directly implements all configuration changes or directly implements none. Thus, whether the configuration change can be implemented by the analyzer directly can be indicated using a configuration option, hardcoded in software, etc. If the analyzer determines that the configuration change can be implemented directly, control then flows to block 708. If the analyzer determines that the configuration change cannot be implemented directly, control then flows to block 710.

At block 708, the analyzer implements the configuration change on the current component. The mechanism used to implement the configuration change on the current component can vary. For example, the current component might implement an API that allows the analyzer to communicate with the current component over a network, allowing the analyzer to indicate the configuration change. As another example, if the analyzer is implemented as part of a storage controller, the analyzer might have direct access to configuration files. Thus, the analyzer might modify configuration settings directly by modifying the values in the configuration files. Additional operations might be part of implementing the configuration change. For example, the analyzer might indicate to the current component that the configuration change has been modified, that the current component should be power cycled, etc. After the analyzer implements the configuration change on the current component, control then flows to block 714.

Control flowed to block 710 if it was determined, at block 706, that the configuration change cannot be implemented directly. At block 710, the analyzer determines an intermediate component to implement the configuration change. The intermediate component can be specified in the implementation plan. For example, if the configuration change is to a storage device, the implementation plan might indicate that the analyzer implements the configuration change by communicating with a storage controller via an API. After the analyzer communicates the configuration change to the storage controller, the storage controller then communicates the configuration change to the storage device itself. Other mechanisms can be used to determine the intermediate component. For example, the intermediate component can be specified in a configuration file, the analyzer can query other components, etc. After the analyzer determines the intermediate component to implement the configuration change, control then flows to block 712.

At block 712, the analyzer sends a request to the intermediate component to implement the configuration change. The mechanism used to operation that the intermediate component implement the configuration change can vary similarly to the operations described at block 708. For example, the analyzer might communicate with the intermediate component via an API, identifying the particular configuration setting and specifying the new value(s), current component, etc. The analyzer might similarly modify a configuration file, which can be read by the intermediate component. The intermediate component can then communicate the configuration change to the current component. After the request is sent to the intermediate component to implement the configuration change, control then flows to block 714.

At block 714, the analyzer receives confirmation that the configuration change has been implemented or validates that the configuration change has been implemented. Confirmation can be received from the current component or intermediate component, depending on which is used to implement the configuration change. The confirmation can vary. For example, an API implemented by the current component might specify that a Boolean value indicating success or failure is sent to the analyzer in response to making a configuration change. The analyzer might implement a separate API that the current or intermediate component communicates with to confirm the implementation of the configuration change. The analyzer might poll the current or intermediate component for the current status of an implementation change. For example, if a configuration change might take a while to implement, instead of waiting for a response from the current or intermediate component, the analyzer might send periodic requests for the status of the configuration change implementation. The analyzer can also validate the configuration change implementation or perform the validation in place of receiving confirmation. The validation can vary depending on the particular configuration change. For example, if the maximum size of each volume in a volume group is lowered, the analyzer can query information about each volume and verify that each volume is, in fact, smaller than the maximum size. After the analyzer has received confirmation that the configuration change has been implemented or validated that the configuration change has been implemented, control then flows to block 716.

At block 716, the analyzer indicates that the current configuration change is implemented. To indicate that the current configuration change has been implemented, the analyzer can set a flag associated with the current configuration change. The flag can be in the implementation plan itself, in a memory location maintained by the analyzer, etc. The analyzer can also indicate that the current configuration change has been implemented by removing the configuration change from the implementation plan, updating a pointer, etc. After the analyzer indicates that the current configuration change is implemented, control then flows to block 718.

At block 718, the analyzer determines if all configuration changes have been implemented. To determine if all configuration changes have been implemented, the analyzer can determine whether all configuration changes specified in the implementation plan have been iterated over. For example, the analyzer might determine whether the end of a list of configuration changes has been reached, whether all configuration changes include an indication that they are implemented, etc. If the analyzer determines that all configuration changes have been implemented, control then flows to block 720. If the analyzer determines that not all configuration changes have been implemented, control then flows back to block 700.

At block 720, the configuration implementation loop ends. Once the configuration loop ends, all configuration changes in the implementation plan will be implemented. At the end of the loop, the analyzer can perform operations such as cleaning up any temporary data, providing a status to a user (via an interface, e-mail, etc.), etc. Once the configuration implementation loop ends, the process ends.

The operations depicted in FIG. 7 can vary. For example, some analyzers might be implemented without support for the scheduling of configuration changes. Thus, the analyzers would not perform the operations depicted at blocks 702 and 704. Similarly, the analyzer might not implement the scheduling of the implementation plan, instead relying on an additional scheduler component to notify the analyzer when a configuration change should be implemented. Additionally, while FIG. 7 depicts each configuration change occurring sequentially, some configuration changes can be made in parallel. For example, a first configuration change might be started, and while the first configuration change is being implemented, a second configuration change might be started as well.

During the initial setup of a storage system, there may be no workload data with which to determine the I/O profile from, and thus an appropriate configuration. In such scenarios, a user can be solicited for data to use for the I/O profile. The configuration can then be determined similar to above. Once sufficient workload data is gathered, the workload data can be analyzed and a configuration determined.

Further, the workload monitoring and analysis of the workload data can be initiated in a variety of ways. For example, a user might request that an analysis of the workload data be performed. The storage system (or other component) can be configured to initiate the analysis of the workload data periodically. Further, the storage system (or other component) might monitor the performance of the storage system. If the performance of the storage system changes a certain amount, the analysis of the workload data can be initiated.

The analysis can vary. For example, the analysis can take into account the variances in workloads associated with specific times of the day or days of the week. For example, during the day the storage system might support business operations, such as storing data for accounting and finance operations, software development, etc. However, during the night when business operations are at a minimum, the storage system might support batch data processing. The different uses might result in drastically different workloads. The analysis can be implemented to focus on the workload at a particular time of day (or range of times). For example, if there is a preference to optimize the storage system for supporting the business operations, the analysis might not use the night workload in the analysis. Similarly, the workload data can be partitioned into multiple periods with each period being given a priority. The workload at the indicated periods can be factored into the analysis based on their priority. In other words, different workloads can be given different weights that are factored into the analysis. Specific workloads that have priority can be indicated in other ways as well. For example, the analysis can analyze workloads associated with specific applications, users, volumes, etc.

The examples above describe the analyzer as analyzing the workload over a particular period of time (e.g., a week). The analyzer can also be implemented to only determine a new configuration after the analyzer has determined that the workload has occurred enough to surpass a particular threshold. For example, the analyzer might generate an I/O profile every day, but only determine and implement a new configuration after determining that a similar I/O profile is generated ninety percent of the time. The specific threshold that triggers the determination and implementation of a new configuration can be user configurable.

A metric that describes whether the I/O operations tend to access sequential or random data measures where the I/O operations fall on a scale from all sequential accesses to all random accesses and can be referred to as the “sequentiality” of the I/O operations. In other words, sequentiality measures the degree to which the I/O operations access random data. A metric that describes whether the I/O operations tend to occur in bursts or at a sustained level measures where the I/O operations fall on a scale from occurring in only bursts to occurring at a single sustained level and can be referred to as the “burstiness” of the I/O operations. In other words, burstiness measures the degree to which the I/O operations occur in bursts.

As example flowcharts, FIGS. 2-4 and 6-7 present operations in an example order that can be deviated from (e.g., operations can be performed in a different order than illustrated or in parallel; additional or fewer operations can be performed, etc.). For example, while FIG. 2 depicts blocks 202, 204, and 206 as occurring sequentially, the operations depicted at blocks 204 and 206 can occur at periodic intervals while the operation at block 202 is being performed. As another example, whether the loop depicted at blocks 308-314 of FIG. 3 is taken can be a configurable option, which might result in a decision block before block 308. As another example, while FIG. 4 depicts determining various aspects of the I/O profile from the workload data at blocks 402-412. As described above, the I/O profile can vary, and thus the operations depicted at blocks 402-412 might not be performed.

As will be appreciated by one skilled in the art, aspects of the disclosures herein may be embodied as a system, method or computer program product. Accordingly, aspects of the disclosures herein may be implemented entirely as hardware, entirely as software (including firmware, resident software, micro-code, etc.) or by combining software and hardware aspects that may all generally be referred to herein as a “circuit,” “module” or “system.” Furthermore, aspects of the disclosures herein may take the form of a program product embodied in one or more machine readable medium(s) having machine readable program code embodied thereon.

Any combination of one or more machine readable medium(s) may be utilized. The machine readable medium may be a machine readable signal medium or a machine readable storage medium. A machine readable storage medium may be, for example, a system, apparatus, or device that uses electronic, magnetic, optical, electromagnetic, infrared, or semiconductor technology, or a combination thereof. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device. A machine readable storage medium does not include transitory, propagating signals.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing.

Program code for carrying out operations for aspects of the disclosures herein may be written in any combination of one or more programming languages, including an object oriented programming language such as the Java® programming language, C++ or the like; a dynamic programming language such as Python; a scripting language such as Perl programming language or PowerShell script language; and conventional procedural programming languages, such as the “C” programming language or similar programming languages. The program code may execute entirely on a stand-alone machine, may execute in a distributed manner across multiple machines, and may execute on one machine while providing results and or accepting input on another machine. Examples of a machine that would execute/interpret/translate program code include a computer, a tablet, a smartphone, a wearable computer, a robot, a biological computing device, etc.

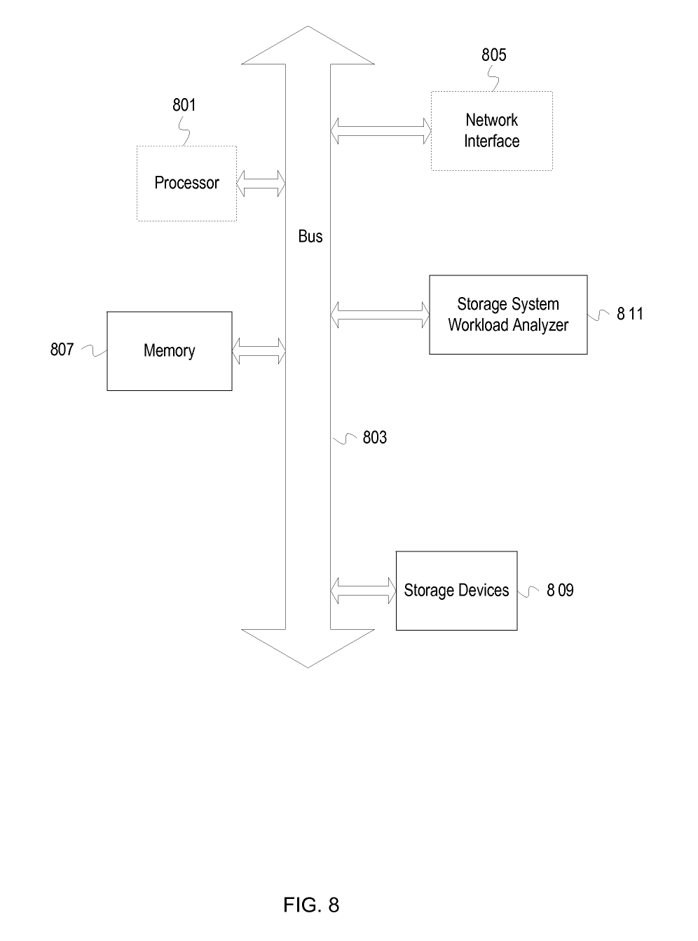

FIG. 8 depicts an example computer system including a storage system workload analyzer. A computer system includes a processor 801 (possibly including multiple processors, multiple cores, multiple nodes, or implementing multi-threading, etc.). The computer system includes memory 807. The memory 807 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computer system also includes a bus 803 (e.g., PCI, ISA, PCI-Express, HyperTransport®, InfiniBand®, NuBus, etc.), a network interface 805 (e.g., an ATM interface, an Ethernet interface, a Frame Relay interface, SONET interface, wireless interface, etc.), and a storage device(s) 809 (e.g., optical storage, magnetic storage, etc.). The computer system also includes a storage system workload analyzer 811. The storage system workload analyzer 811 analyzes a storage system workload to determine storage system I/O profile. The storage system workload analyzer 811 uses the I/O profile to determine a configuration for the storage system. The storage system workload analyzer 811 can also determine an implementation plan for the configuration and implement the actual configuration. Any one of these functionalities may be partially (or entirely) implemented in hardware or on the processor 801. For example, the functionality may be implemented with an application specific integrated circuit, in logic implemented in the processing unit 801, in a co-processor on a peripheral device or card, etc. Further, realizations may include fewer or additional components not illustrated in FIG. 8 (e.g., video cards, audio cards, additional network interfaces, peripheral devices, etc.). The processor 801, the storage device(s) 809, and the network interface 805 are coupled to the bus 803. Although illustrated as being coupled to the bus 803, the memory 807 may be coupled to the processor 801.

While the examples are described with reference to various examples and exploitations, it will be understood that these examples are illustrative and that the scope of the disclosures herein is not limited to them. In general, techniques for storage system workload analysis as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosures herein. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosures herein.

As used herein, the term “or” is inclusive unless otherwise explicitly noted. Thus, the phrase “at least one of A, B, or C” is satisfied by any element from the set {A, B, C} or any combination thereof, including multiples of any element.

What is claimed is:

1. A method comprising:
analyzing storage system workload data associated with a storage system, wherein the workload data comprises indications of input and output operations associated with the storage system;
determining a storage system configuration based, at least in part, on said analyzing of the storage system workload data; and
generating an implementation plan, wherein the implementation plan comprises one or more operations for implementing the storage system configuration.

2. The method of claim 1, wherein said analyzing of the storage system workload data comprises determining at least one of:
a read-to-write ratio based, at least in part, on the workload data;
an amount of data referenced by the input and output operations;
a sequentiality of the input and output operations; and
a burstiness of the input and output operations.

3. The method of claim 2, wherein said determining the storage system configuration based, at least in part, on said analyzing of the storage system workload data comprises determining a storage system configuration based, at least in part, on at least one of the read-to-write ratio, the amount of data referenced by the input and output operations, the sequentiality of the input and output operations, and the burstiness of the input and output operations.

4. The method of claim 2, wherein said determining the amount of data referenced by the input and output operations comprises at least one of:
determining an average amount of data referenced by the input and output operations;
determining a standard deviation associated with the amount of data referenced by the input and output operations; and
determining an amount of data referenced by a specific percentage of the input and output operations.

5. The method of claim 2, wherein said determining the sequentiality of the input and output operations comprises determining groups of the input and output operations, wherein a group of the input and output operations is characterized by each input and output operation accessing data that is within a predetermined distance from a previous input and output operation.

6. The method of claim 2, wherein said determining the burstiness of the input and output operations comprises at least one of:
determining a volatility of input and output operation traffic levels;
determining a rate of increase and decrease of input and output operation traffic levels; and
determining minimum and maximum input and output operation traffic levels over one or more time periods.

7. The method of claim 1, wherein said generating the implementation plan comprises:
analyzing the storage system workload data to identify traffic patterns associated with the storage system;
identifying a period of time in which storage system traffic is low; and
indicating that a first of the one or more operations is to be performed during the period of time in which the storage system traffic is low.

8. The method of claim 1 further comprising:
selecting a first of the one or more operations;
determining a first of a plurality of storage system components associated with the first of the one or more operations; and
indicating, to the first of the plurality of storage system components, a storage system configuration setting in accordance with the first of the one or more operations.

9. A non-transitory machine readable medium having stored thereon instructions for automatically configuring a storage system based on workload monitoring, comprising machine executable code which, when executed by at least one machine, causes the at least one machine to:
generate an input and output profile associated with a storage system, wherein the input and output profile comprises values indicating one or more characteristics of the storage system;
select a first of a plurality of storage system configurations based, at least in part, on the input and output profile, wherein the first of the plurality of storage system configurations comprises one or more configuration settings; and
implement a first of the one or more configuration settings.

10. The non-transitory machine readable medium of claim 9, wherein the machine executable code which, when executed by at least one machine, causes the at least one machine to generate an input and output profile associated with the storage system comprises machine executable code which, when executed by at least one machine, causes the at least one machine to:
read workload data from a data source, wherein the workload data is associated with the storage system, wherein the workload data comprises indications of input and output operations; and
determine one or more characteristics of the storage system based, at least in part, on the workload data, wherein the input and output profile comprises the one or more characteristics of the storage system.

11. The non-transitory machine readable medium of claim 10, wherein the input and output profile comprises:
a read-to-write ratio;
an amount of data referenced by the input and output operations;
a sequentiality of the input and output operations; and
a burstiness of the input and output operations.

12. The non-transitory machine readable medium of claim 11 further comprising machine executable code which, when executed by at least one machine, causes the at least one machine to:
determine whether the amount of data referenced by the input and output operations is greater than a threshold;
responsive to a determination that the amount of data referenced by the input and output operations is not greater than the threshold, determining a first cache block size and a first segment size; and
responsive to a determination that the amount of data referenced by the input and output operations is greater than the threshold, determining a second cache block size and a second segment size, wherein the second cache block size is greater than the first cache block size, wherein the second segment size is greater than the first segment size.

13. The non-transitory machine readable medium of claim 11 further comprising machine executable code which, when executed by at least one machine, causes the at least one machine to:
determine whether the read-to-write ratio indicates that write operations are greater than a threshold;
responsive to a determination that the read-to-write ratio indicates that write operations are not greater than a threshold, determining that a write cache should be disabled; and
responsive to a determination that the read-to-write ratio indicates that write operations are greater than a threshold, determining that the write cache should be enabled.

14. The non-transitory machine readable medium of claim 9, wherein the machine executable code which, when executed by at least one machine, causes the at least one machine to select the first of the plurality of storage system configurations based, at least in part, on the input and output profile comprises machine executable code which, when executed by at least one machine, causes the at least one machine to:
load a performance tuning rule lookup table, wherein the performance tuning rule lookup table comprises a plurality of rows, wherein each of the plurality of rows corresponds to a storage system configuration of the plurality of storage system configurations, wherein the performance tuning rule lookup table is indexed by values corresponding to the one or more characteristics of the storage system;
determine a row of the plurality of rows, wherein the row of the plurality of rows has an index corresponding to the values indicated by the input and output profile; and
select the row of the plurality of rows, wherein the first of the plurality of storage system configurations comprises the storage system configuration associated with the row of the plurality of rows.

15. The non-transitory machine readable medium of claim 14, wherein each of the plurality of rows of the performance tuning rule lookup table comprises an indication of a RAID level, a cache block size, whether a write cache is enabled, whether cache mirroring is enabled, and a segment size.

16. An apparatus comprising:
a processor; and
a machine readable storage medium having program code stored therein that is executable by the processor to cause the apparatus to:
analyze storage system workload data associated with a storage system, wherein the workload data comprises indications of input and output operations associated with the storage system;
determine a storage system configuration based, at least in part, on said analyzing of the storage system workload data; and
generate an implementation plan, wherein the implementation plan comprises one or more operations for implementing the storage system configuration.

17. The apparatus of claim 16, wherein said program code being executable by the processor to cause the apparatus to generate an implementation plan comprises program code executable by the processor to cause the apparatus to:
identify traffic patterns of the storage system based, at least in part, on the storage system workload data;
determine a period of time in which storage system traffic is low; and
indicate that a first of the one or more operations is to be performed during the period of time in which the storage system traffic is low.

18. The apparatus of claim 17, wherein said program code being executable by the processor to cause the apparatus to generate an implementation plan further comprises program code executable by the processor to cause the apparatus to:
determine that execution of the first of the one or more operations will have an impact on the performance of the storage system greater than a threshold;
wherein said program code being executable by the processor to cause the apparatus to indicate that a first of the one or more operations is to be performed during the period of time in which the storage system traffic is low is responsive to a determination that execution of the first of the one or more operations will have an impact on the performance of the storage system greater than the threshold.

19. The apparatus of claim 18, wherein said program code being executable by the processor to cause the apparatus to generate an implementation plan further comprises program code executable by the processor to cause the apparatus to:
estimate a length of time in which the first of the one or more operations can be completed; and
determine that the period of time in which the storage system traffic is low is longer than the length of time in which the first of the one or more operations can be completed;
wherein said program code being executable by the processor to cause the apparatus to indicate that a first of the one or more operations is to be performed during the period of time in which the storage system traffic is low is further responsive to a determination that the period of time in which the storage system traffic is low is longer than the length of time in which the first of the one or more operations can be completed.

20. The apparatus of claim 16, wherein said program code being executable by the processor cause the apparatus to generate an implementation plan further comprises program code executable by the processor to cause the apparatus to:
determine that a first of the one or more operations is dependent on a second of the one or more operations; and
in response to a determination that the first of the one or more operations is dependent on the second of the one or more operations, indicate that the first of the one or more operations is to be performed after the second of the one or more operations.
